(19) United States
(12) Patent Application Publication
(10) Pub. No.: US 2019/0158905 A1
(43) Pub. Date: May 23, 2019

(54) Processing Video Usage Information for the Delivery of Advertising

(71) Applicant: Vilynx, Inc., Palo Alto, CA (US)

(72) Inventors: Elisenda Bou Balust, Barcelona (ES); Juan Carlos Riveiro Insua, Menlo Park, CA (US); Mario Nemirovsky, Barcelona (ES)

(21) Appl. No.: 16/254,445

(22) Filed: Jan. 22, 2019

Related U.S. Application Data
(63) Continuation of application No. 14/833,036, filed on Aug. 21, 2015.

(51) Int. Cl. H04N 21/2668; G06Q 30/02; H04N 21/658; H04N 21/442; H04N 21/233; H04N 21/258; H04N 21/8549; H04N 21/25; H04N 21/234; H04N 21/81

(52) U.S. Cl. CPC H04N 21/2668; G06Q 30/02; H04N 21/6582; H04N 21/44204; H04N 21/812; H04N 21/25891; H04N 21/8549; H04N 21/251; H04N 21/23418; H04N 21/233

(57) ABSTRACT

A system and method is provided for generating summaries of video clips and then utilizing a source of data indicative of the consumption by viewers of those video summaries. In particular, summaries of videos are published and audience data is collected regarding the usage of those summaries, including which summaries are viewed, how they are viewed, the duration of viewing and how often. This usage information may be utilized in a variety of ways. In one embodiment, the usage information is fed into a machine learning algorithm that identifies, updates and optimizes groupings of related videos and scores of significant portions of those videos in order to improve the selection of the summary. In this way the usage information is used to find a summary that better engages the audience. In another embodiment usage information is used to predict popularity of videos. In still another embodiment usage information is used to assist in the display of advertising to users.

### BACKGROUND

The present disclosure relates to the field of video analysis and more particularly to the creation of summaries of videos and the collection and processing of usage information of those summaries.

In recent years there has been an explosion of video information being generated and consumed. The availability of inexpensive digital video capability, such as on smart phones, tablets and high definition cameras, and the access to high speed global networks including the Internet have allowed for the rapid expansion of video creation and distribution by individuals and businesses. This has also lead to a rapidly increasing demand for videos on web sites and social networks. Short video clips that are user generated, created by news organizations to convey information, or created by sellers to describe or promote a product or service are common on the Internet today.

Frequently such short videos are presented to users with a single static frame from the video initially displayed. Often a mouse-over or click event will start the video from the beginning of the clip. In such cases audience engagement may be limited. U.S. Pat. No. 8,869,198, incorporated herein by reference, describes a system and method for extracting information from videos to create summaries of the videos. In this system, key elements are recognized and pixels are extracted related to the key elements from a series of video frames. A short sequence of portions of video frames, referred to as a “video bit” is extracted from the original video based on the key element analysis. The summaries comprise a collection of these video bits. In this way the video summary can be a set of excerpts in both space and time from the original video. A plurality of video bits may be displayed in a user interface, sequentially or simultaneously or a combination of both. The system disclosed in the aforementioned patent does not utilize usage information of the video summaries.

### SUMMARY

A system and method is provided for generating summaries of video clips and then utilizing a source of data indicative of the consumption by viewers of those video summaries. In particular, summaries of videos are published and audience data is collected regarding the usage of those summaries, including which summaries are viewed, how they are viewed, the duration of viewing and how often. This usage information may be utilized in a variety of ways. In one embodiment, the usage information is fed into a machine learning algorithm that identifies, updates and optimizes groupings of related videos and scores of significant portions of those videos in order to improve the selection of the summary. In this way the usage information is used to find a summary that better engages the audience. In another embodiment usage information is used to predict popularity of videos. In still another embodiment usage information is used to assist in the display of advertising to users.

### BRIEF DESCRIPTION OF THE DRAWINGS

FIG. 1 illustrates an embodiment of a server providing a video summary to client devices and the collection of usage information.

FIG. 2 illustrates an embodiment of the processing of video summary usage information to improve the selection of video summaries.

FIG. 3 illustrates an embodiment of the processing of video summary usage information for popularity prediction.

FIG. 4 illustrates an embodiment of the processing of video summary usage information to assist in the display of advertising.

### DETAILED DESCRIPTION

The systems and methods disclosed are based on the collection of information on the usage of video summaries. In one embodiment, this usage information feeds a machine-learning algorithm to assist in finding the best summary that engages the audience. This can be useful in increasing click-through (i.e. a selection by the user to view the original video clip from which the summary was created), or as an end in itself to increase audience engagement with the summaries regardless of click-through or where no click-through exists. Usage information can also be used to detect viewing patterns and predict which video clips will become popular (e.g. “viral” videos), and can also be used to decide when, where and to whom to display advertisements. The decision on the display of advertising can be based on criteria such as a display after a certain number of summary displays, a selection of a particular advertisement to display and the anticipated level of interest of the individual user. Usage information can also be used to decide which videos should be displayed to which users and to select the order in which videos are displayed to a user.

The usage information is based on data that is collected about how video information is consumed. Specifically, information is collected on how video summaries are viewed (e.g. time spent viewing a summary, where on the video frame the mouse has been placed, at what point during the summary the mouse is clicked, etc.). Such information is used to assess the level of audience engagement with the summary, and the rate of how often the user clicks through to view the underlying video clip. In general, a goal is to increase the degree to which the user engages with the summary. It can also be a goal to increase the number of times the user views the original video clip, and the degree to which the user engages with the original video. Further, it can be a goal to increase advertisement consumption and/or advertisement interaction.

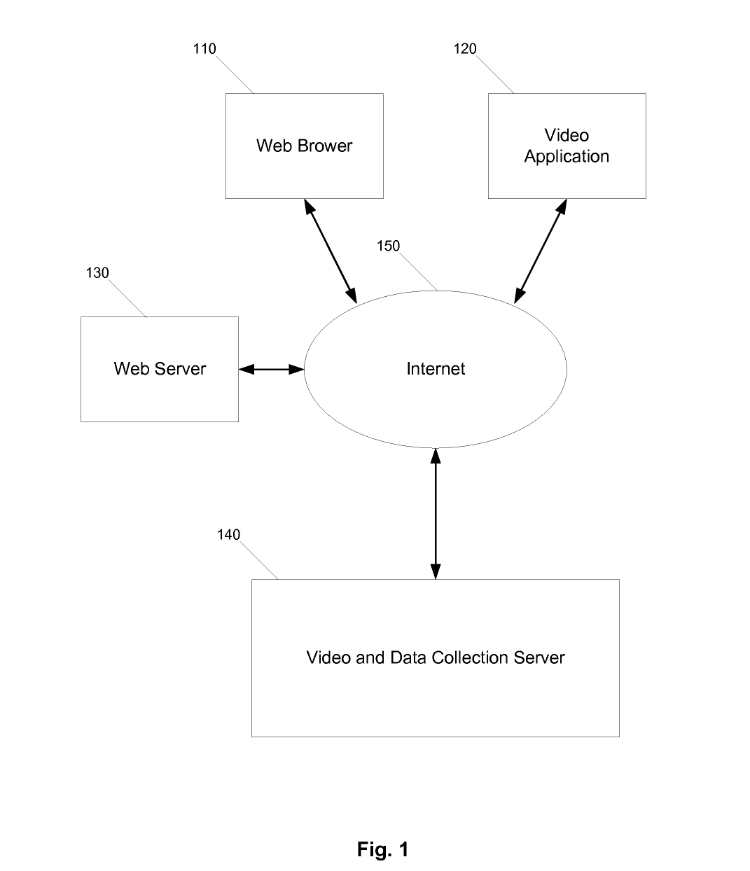

FIG. 1 illustrates an embodiment in which a video and data collection server accessible over the Internet communicates with client devices. Examples of client devices that allow users to view video summaries and video clips include Web Brower 110 and Video Application 120. Web Browser 110 could be any web-based client program that communicates with a Web Server 130 and displays content to a user, such as desktop web browers such as Safari, Chome, Firefox, Internet Explorer and Edge. Web Browser 110 could also be a mobile based web browser such as those available on Android or iPhone devices, or could be a web browser built into a smart TV or set-top box. In one embodiment Web Browser 110 establishes a connection with Web Server 130 and receives embedded content that directs Web Browser 110 to retrieve content from Video and Data Collection Server 140. A variety of mechanisms can be used to embed a reference to Video and Data Collection Server 140 in documents retrieved from Web Server 130, such as the use of embedded scripts such as JavaScript (ECMAScript) or an applet written in Java or other programming language. Web Browser 110 retrieves and displays video summaries from Video and Data Collection Server 140 and usage information is returned. Such video summaries may be displayed within the web page served by Web Server 130. Because Web Browser 110 interacts with Video and Data Collection server 140 for the display of video summaries, only a minor modification is needed to documents hosted on front end Web Server 130.

Communication between Web Brower 110, Web Server 130 and Video and Data Collection Server 140 takes place over the Internet 150 in one embodiment. In alternative embodiment any suitable local or wide area network can be used and a variety of transport protocols can be used. Video and Data Collection Server 140 need not be a single machine at a dedicated location but can be a distributed, cloud based, server. In one embodiment Amazon Web Services are used to host Video and Data Collection Server 140, although other cloud computing platforms could be utilized.

In some embodiments, rather than the use of Web Server 110 to display video content to users, a dedicated Video Application 120 can be utilized. Video Application 120 can be running a desktop or laptop computer or on a mobile device such as a smartphone or tablet, or can be an application that is part of a smart TV or set-top box. In this case, rather than interacting with Web Server 130, Video Application 120 communicates directly with Video and Data Collection Server 140. Video Application 120 could be any desktop or mobile application suitable to display content including video, and is configured to retrieve video summaries from Video and Data Collection Server 140.

In both the case of Web Brower 110 and Video Application 120 information regarding the consumption of the video summary is sent back to Video and Data Collection Server 140. In one embodiment such video usage information is sent back over the same network and to the same machine from which the video summaries are retrieved. In other embodiments, alternative arrangements for collection of usage data are made, such as the use of other networks and/or other protocols, or by separating Video and Data Collection Server 140 into multiple machines or groups of machines including those that serve the video summaries and those that collect the usage information.

In some embodiments, video usage information is used to feed a machine learning algorithm. Machine learning refers generally to techniques and algorithms that allow a system to acquire information, or learn, without being explicitly programmed. This is usually expressed in terms of a performance on a particular task and the degree to which experience increases the performance on that task. There are two main types of machine learning, supervised learning and unsupervised learning. Supervised learning uses data sets where the answer or result for each data item is known, and typically involves regression or classification problems to find a best fit. Unsupervised learning uses data sets where there are no answers or results known for each data item, and typically involves finding clusters or groups of data that share certain properties.

Some embodiments of the present inventions utilize unsupervised learning to identify clusters of videos. Video clips are clustered into video groups and subgroups based on specific properties such as: color pattern, stability, movement, number and type of objects and/or people, etc. Summaries are created for video clips and an unsupervised machine learning algorithm using audience video consumption information is used to improve the selection of summaries for each video within a group or subgroup of videos. Because the videos within a group have similar properties, usage information for one video in a group is useful in optimizing summary selection for other videos in the same group. In this way, the machine learning algorithm learns and updates the group and subgroup summary selection.

In this disclosure we use the term group and subgroup to refer to a set of videos that are similar in one or more parameters, described in detail below, in individual frames, sequences of frames and/or throughout the video. Groups and subgroups of videos can share some of the parameters for a subset of frames or they may share parameters when aggregated throughout the video duration. Selection of a summary for a video is based on a score, which is a performance metric computed based on the parameters of the video, and the scores of the other videos in the group, and as explained below the audience interaction.

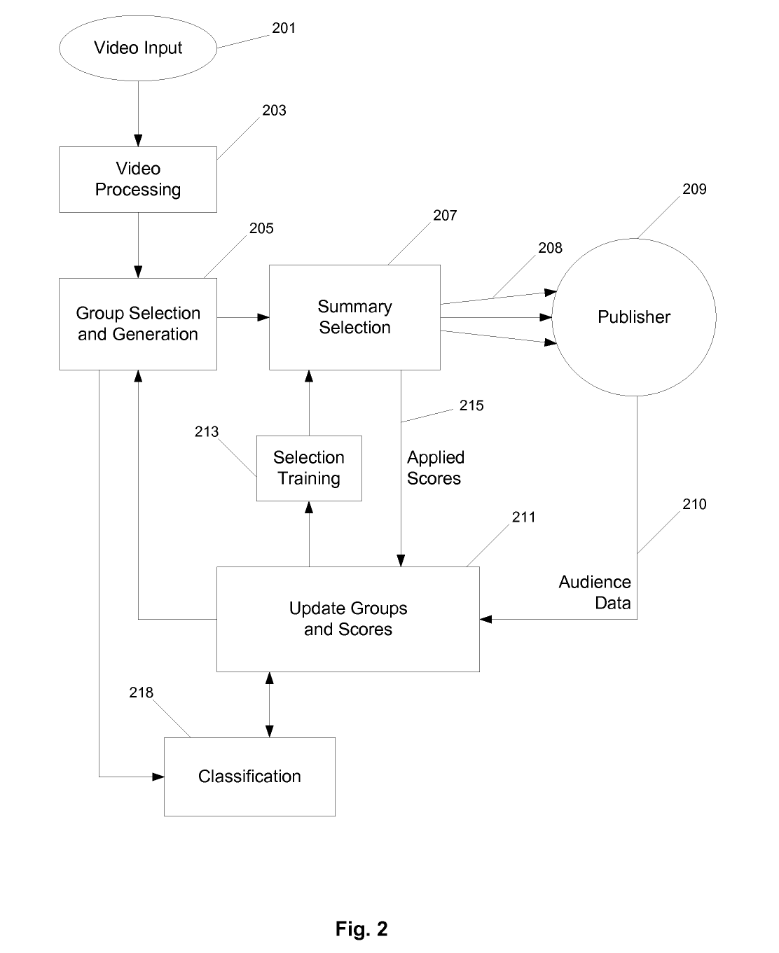

FIG. 2 illustrates an embodiment that utilizes video summary usage information to improve the selection of video summaries. Video input 201 represents the introduction of a video clip into the system for which summary generation and selection is desired. This video input could come from a number of sources, including user generated content, marketing and promotional videos, or news videos generated by news gathering organizations, for example. In an embodiment Video Input 201 is uploaded over a network to a computerized system where subsequent processing takes place. Video Input 201 may be uploaded automatically or manually. By using a Media RSS (MRSS) feed, Video Input 201 may be automatically uploaded by a video processing system. Video Input 201 may also be manually uploaded using a user interface from a local computer or a cloud based storage account. In other embodiments, videos are automatically crawled from the owner's website. In cases where a video is retrieved directly from a web site, context information may be utilized to enhance the understanding of the video. For example, the placement of the video within the web page and the surrounding content may provide useful information regarding the content of the video. There may be other content, such as public comments, that may further relate to video content.

In the case the videos are manually uploaded, the user may provide information regarding the content of the video that may be utilized. In one embodiment a “dashboard” is provided to a user to assist in the manual uploading of a video. Such a dashboard can be used to allow a user to incorporate manually generated summary information that is used as metadata input to a machine learning algorithm as explained below.

Video Processing 203 consists of processing the Video Input 201 to obtain a set of values for a number of different parameters or indices. These values are generated for each frame, for sequences of frames and for the overall video. In one embodiment, the video is initially divided into slots of fixed duration, for example five seconds, and parameters are determined for each slot. In alternative embodiments, slots could have other durations, could be variable in size, and could have starting and ending points that are determined dynamically based on the video content. Slots may also overlap such that an individual frame is part of more than one slot, and in alternative embodiments slots may exist in a hierarchy such that one slot consists of a subset of frames included in another slot (a sub-slot).

In one embodiment, slots of five seconds in duration are used to create summaries of the original video clip. A number of tradeoffs can be used to determine an optimal slot size for creating a summary. A slot size that is too small may result in insufficient context to provide a picture of the original video clip. A slot size that is too large may result in a “spoiler” in which too much of the original video clip is revealed which may reduce the rate of click-through. In some embodiments, click-through to the original video clip may be less important or irrelevant and audience engagement with the video summaries may be the primary goal. In such an embodiment an optimal slot size may be longer and the optimal number of slots used to create a summary may be greater.

The values generated by Video Processing 203 can be generally placed in three categories: Image Parameters, Audio Parameters and Metadata. Image parameters may include one or more of the following:

1. a color vector of the frame, slot and/or video;

2. a pixel mobility index of the frame, slot and/or video;

3. the background area of the frame, slot and/or video;

4. the foreground area of the frame, slot and/or video;

5. the amount of area occupied by a feature such as a person, object or face of the frame, slot and/or video;

6. recurring times of a feature such as a person, object or face within the frame, slot and/or video (e.g. how many times a person appears);

7. the location of a feature such as a person, object or face within the frame, slot and/or video;

8. pixel and image statistics within the frame, slot and/or video (e.g. number of objects, number of people, sizes of objects, etc.);

9. text or recognizable tags within the frame, slot and/or video;

10. frame and/or slot correlation (i.e. the correlation of a frame or slot with previous or subsequent frames and/or slots);

11. image properties such as resolution, blur, sharpening and/or noise of the frame, slot and/or video.

Audio Parameters may include one or more of the following:

1. pitch shifts of the frame, slot and/or video;

2. time shortening or stretching of the frame, slot and/or video (i.e. a change of audio speed);

3. a noise index of the frame, slot and/or video;

4. volume shifts of the frame, slot and/or video;

5. audio recognition information.

In the case of audio recognition information, recognized words can be matched to a list of key words. Some key words from the list can be defined globally for all videos, or they can be specific to a group of videos. Also, part of the list of key words can be based on metadata information described below. Recurring times of audio key words used in the video can also be used, which allows the use of statistical methods to characterize the importance of that particular key word. The volume of a key word or audio element can also be used to characterize a level of relevance. Another analytic is the number of unique voices speaking the same key word or audio element simultaneously and/or throughout the video.

In one embodiment, Video Processing 203 performs matching of image features such as a person, object or face within a frame, slot and/or video with audio key words and/or elements. If there are multiple occurrences of matching in time of image features with audio features, this can be used a relevant information is a relevant parameters.

Metadata includes information obtained using the video title or through the publisher's site or other sites or social networks which contain the same video and may include one or more of the following:

1. title of video;

2. location within a web page of the video;

3. content on web page surrounding the video;

4. comments to the video;

5. result of analytics about how the video has been shared in social media.

In one embodiment Video Processing 203 performs matching of image features and/or audio key words or elements with metadata words from the video. Audio key words can be matched with metadata text and image features can be matched with metadata text. Finding connections between image features, audio key words or elements and the metadata of the video is part of the machine learning goals.

It can be appreciated that there are other similar Image Parameters, Audio Parameters and Metadata that may be generated during video processing 203. In alternative embodiments, a subset of the parameters listed above and/or different characteristics of the video may be extracted at this stage. It is also the case that the machine learning algorithm can re-process and re-analyze the summary based on audience data to find new parameters that had been not raised in a previous analysis. Moreover, a machine learning algorithm could be applied on a subset of chosen summaries to find coincidences between them that could explain the audience behaviors associated to them.

After video processing, the information collected is sent to Group Selection and Generation 205. During Group Selection and Generation 205, the resulting values from Video Processing 203 are used to assign the video to an already defined group/subgroup or to create a new group/subgroup. This determination is made based on the percentage of shared indices between the new video and the other videos within the existing groups. If the new video has parameter values that are sufficiently different than any existing group, then the parameter information is sent to Classification 218, which creates a new group or subgroup, passing new group/subgroup information to Update Groups and Scores 211, which then updates information in Group Selection and Generation 205 thereby assigning the new video to a new group/subgroup. When we discuss a “shared index’ we mean that there is one or more parameters that are within a certain range of the parameters that the group has.

Videos are assigned to a group/subgroup based on a percentage similarity with the parameter pool and if similarities are not close enough a new group/subgroup is generated. If similarities are important but there are new parameters to be added the pool, a subgroup can be created. If a video is similar to more than one group, a new group is created inheriting the parameter pool from its parent group. New parameters can be aggregated to the parameter pool, which would cause the need for a group re-generation. In alternative embodiments, a hierarchy of groups and subgroups of any number of levels can be created.

In one embodiment one or more thresholds are used to determine whether a new video is close enough to an existing group or subgroup. These thresholds may be adjusted dynamically based on feedback as described below. In some embodiments, a video may be assigned to more than one group/subgroup during Group Selection and Generation 205.

Once a group for the video input 201 is selected or generated, the group information is sent to Summary Selection 207, which assigns a “score” to the video. The score is an aggregated performance metric achieved by applying a given function (which depends upon a machine learning algorithm) to the individual scores for the parameter values described above. The score created in this step depends upon the scores of the group. As described below, feedback from video summary usage is used to modify the performance metric used to compute the score. An unsupervised machine learning algorithm is used to adjust the performance metric.

The parameter values discussed above are evaluated for every single frame and aggregated by slots. The evaluation process takes into account criteria such as the space of the occurrence and time. Several figures of merit are applied to the aggregated slot parameters, each of them resulting in a summary selection. The figure of merit is then calculated based on a combination of the parameter pool evaluation weighted by the group indexes (with a given variation). The resulting score is applied to each individual frame and/or group of frames, resulting in a list of summaries ordered by the figure of merit. In one embodiment the ordered list of summaries is a list of video slots such that the slots most likely to engage the user are higher on the list.

One or more summaries 208 are then served to Publisher 209, which allows them to be available for display to a user on a web server or other machine such as discussed above in connection with FIG. 1. In one embodiment, Video and Data Collection Server 140 receives the summaries for a given video and can deliver those summaries to users via Web Brower 110 or Video Application 120. Summaries displayed to users may consist of one or more video slots in one embodiment. Multiple video slots may be displayed simultaneously within the same video window or may be displayed in sequence, or they may be displayed using a combination. The decision of how many slots to display and when in some embodiments is made by the Publisher 209. Some publishers prefer one or more in sequence while others prefer showing multiple slots in parallel. In general, more slots in parallel means more information to look at by the user and can be busy in terms of presentation design, while a single slot at a time is less busy but also provides less information. The decision between in sequence or parallel design can also be based on bandwidth.

Video consumption (usage) information for the summaries is obtained from Video and Data Collection Server 140. Usage information may consist of one or more of the following:

1. number of seconds a user spent watching a given summary;

2. area within the summary window that is clicked;

3. area within the summary in which the mouse has been placed;

4. number of times a user sees a summary;

5. time of a user mouse click relative to the playback of the summary;

6. drop time (e.g. the time at which a user does a mouse-out event to stop watching the summary without a click);

7. click throughs to view the original video clip;

8. total summary views;

9. direct clicks (i.e. clicks without watching the summary);

10. time spent by the user on the site;

11. time spent by the user interacting with the summaries (individually, a selected set of summaries based on type of content, or aggregated for all summaries).

Also, in one embodiment different versions of the summary are served to different users either in one or multiple audiences and audience data includes the number of clicks to each versions of the summary for a given audience. The data described above is then obtained through the interaction of such users with the different summary variations and then used to decide how to improve the indexes of the algorithm's figure of merit.

The Audience Data 210 discussed above is sent to Update Groups and Scores 211. Based upon the Audience Data 210, a given video can be re-assigned to a different group/subgroup or a new group/subgroup can be created. Update Groups and Scores 211 may re-assign a video to another group if needed and also forwards the Audience Data 210 to Selection Training 213 and to Group Selection 205.

Selection Training 213 causes the indexes of the performance function used in Summary Selection 207 to be updated for a video and group of videos based upon the Audience Data 210. This information is then forwarded to Summary Selection 207 in order to be used for the video being summarized and to the rest of videos of the group. The performance function depends upon the initial group score and the result of Selection Training 213.

In one embodiment a group is defined by two things: a) the shared indices within a certain range; and b) the combination of indices that allow us to decide which slots are the best moments of the video. For the combination of indices, Applied Scores 215 are sent to Update Groups and Scores 211. This information is used to update groups in the sense that if the scores have nothing to do with the ones from the rest of the group then a new subgroup could be created. As noted above, Classification 218 causes the creation of a new group/subgroup or the partition of existing group into multiple groups based on the resulting values for the indexes. Update Groups and Scores 211 is responsible to assign the “Score” function to the given group.

As an illustrative example of some of the features describe above, consider a video within a group of soccer videos. Such a video would share parameters within the group such as green color, a specific quantity of movement, small figures, etc. Now suppose it is determined that the summary that causes the most audience engagement is not a sequence of a goal, but a sequence showing a person running through the field and stealing the ball. In this case, the score will be sent to Update Groups and Scores 211 and it might be decided to create a new subgroup within the soccer group, which could be considered a running scene in a soccer video.

In the above discussion, note that machine learning is used in a number of differ aspects. In Group Selection and Generation 205, machine learning is used to create groups of videos based on frame, slot and video information (processing data) and on data from the audience (the results of the audience data and results from Update Groups and Scores 211). In Summary Selection 207, machine learning is used to decide which parameters should be used for the scoring function. In other words, to decide which parameters of the parameter pool are significant for a given group of videos. In Update Groups and Scores 211 and Selection Training 213, machine learning is used to decide how to score every parameter used in the scoring function. In other words, to decide the value of each of the parameters within the parameters in the scoring function. In this case previous information from group videos is used together with the audience behavior.

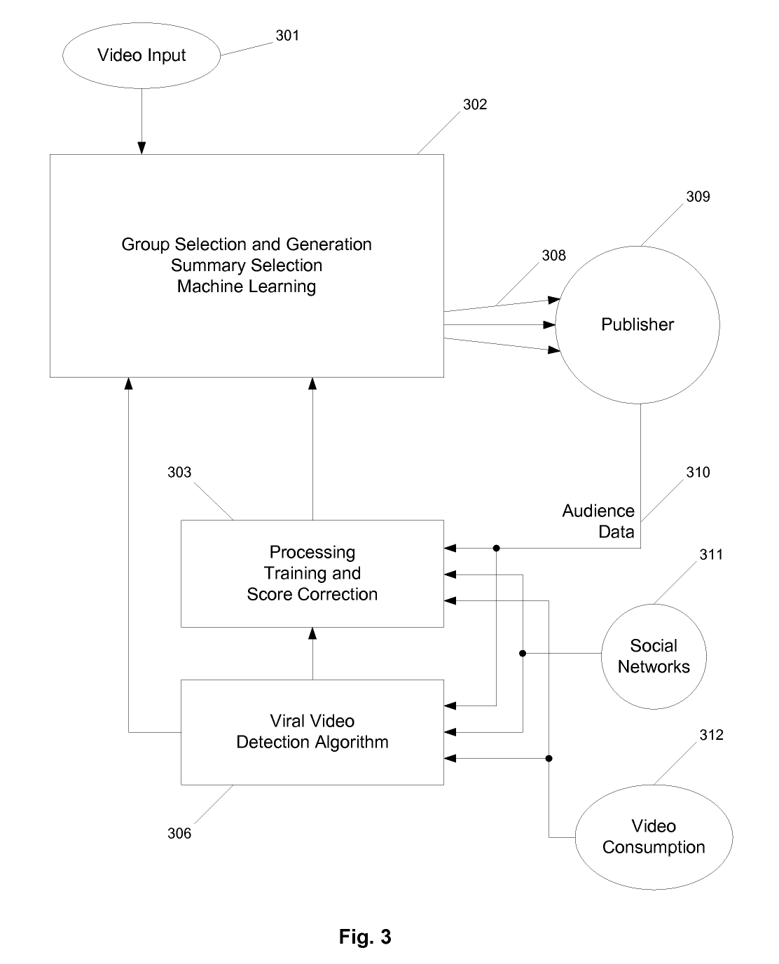

In addition to video summary usage data, data may be collected from other sources, and video summary usage data can be utilized for other purposes. FIG. 3 illustrates an embodiment where data is collected from video summary usage as well as other sources and an algorithm is used to predict whether or not a video will have a huge impact (i.e. become “viral”). Prediction of viral videos may be useful for a number of different reasons. A viral video may be more important to advertisers and it may be helpful to know this in advance. It may also be useful for providers of potentially viral videos to have this information so they can promote such videos in ways that may increase their exposure. Moreover, viral prediction can be used to decide to which videos should the ads be placed.

Social networking data can be collected that indicates which videos have a high level of viewership. Also, video clip consumption data such as summary click through, engagement time, video views, impressions and audience behavior can be retrieved. The summary data, social networking data and video consumption data can be used to predict which videos are going to become viral.

In the embodiment illustrated in FIG. 3, the grouping phase and summary selection phase may be similar to those described in connection with FIG. 2. A detection algorithm retrieves data from the audience and predicts when a video is going to be viral. The results (whether a video is viral or not) are incorporated into a machine learning algorithm to improve viral detection for a given group. Also, subgroup generation (viral video) and score correction can be applied.

Video Input 301 is the video that is uploaded to the system as discussed in conjunction with FIG. 2. Video Input 301 is processed and the values for the Image Parameters, Audio Parameters and Metadata are obtained for the video. This set of metrics together with data from previous videos is used to assign the video to an existing group or to generate a new group. The video is assigned to an existing group if there is enough similarity within this video and the videos pertaining to an existing group according to a variable threshold. If the threshold is not achieved for any given group a new group or subgroup is generated and the video is assigned to it. Moreover, if the video has characteristics from more than one group, a new subgroup may be generated also. In some embodiments, the video may belong to two or more groups, a subgroup is created that belongs to two or more groups, or a new group is created with a combination of parameters matching groups.

Once the Video Input 301 is assigned to a group/subgroup, an algorithm used to calculate the score of the slots (or sequence of frames) of the video is obtained from the group and evaluated, resulting in a list of scored slots. If the video is the first video of a group, a basic score function will be applied. If it is the first video of a newly generated subgroup then characteristics from the algorithms used in their parents are used as a first set.

A given number of slots produced from 302 are then served to Publisher 309. As noted above in connection with FIG. 1, in some embodiments the publisher decides how many of the slots should be served on their website or application and whether they should be served in sequence, in parallel or a combination of both.

The audience behavior when looking at the publisher's videos is then tracked and usage information 310 is returned. Data from Social Networks 311 and Video Consumption 312 for that video is sent to Processing Training and Score Correction 303 and to Viral Video Detection 306 which compares the calculated potentiality of the video to becoming a viral and the results given by the audience.

Video Consumption 312 is data from the consumption of that video either obtained from the publisher's site or through other sites in which the same video is served. Social Networks 311 data may be retrieved by querying one or more social networks to obtain the audience behavior of a given video. For example, the number of comments, number of shares, video views, can be retrieved.

Processing Training and Score Correction 303 uses machine learning to update the scoring algorithm for each group so as to improve the score computation algorithm for the video group. If the obtained results do not fit the previous results obtained from the videos within the same group (for example according to a threshold), then the video can be reassigned to a different group. At this point the video slots would be recalculated. In the machine learning algorithm, multiple parameters are taken into account such as: audience behavior with the summary of the video, data from social networks (comments, thumbnails selected to engage the user in social networks, number of shares) and video consumption (which parts of the video have been watched by the users most, video consumption). The algorithm then retrieves the statistics for the video and updates the scoring index trying to match the image thumbnails or video summaries that got the best results).

Viral Video Detection 306 computes the probability of a video becoming viral based on the audience behavior, the results obtained from the Image Parameters, Audio Parameters and Metadata indexes for that video, and previous results obtained from videos within the same group. The information obtained in 306 can be sent to the publisher. Note that Viral Video Detection 306 can operate after a video has become viral as a training mechanism, while a video is becoming viral to detect increase in popularity as it is happening, and also before a video has been published to predict the likelihood of it becoming viral.

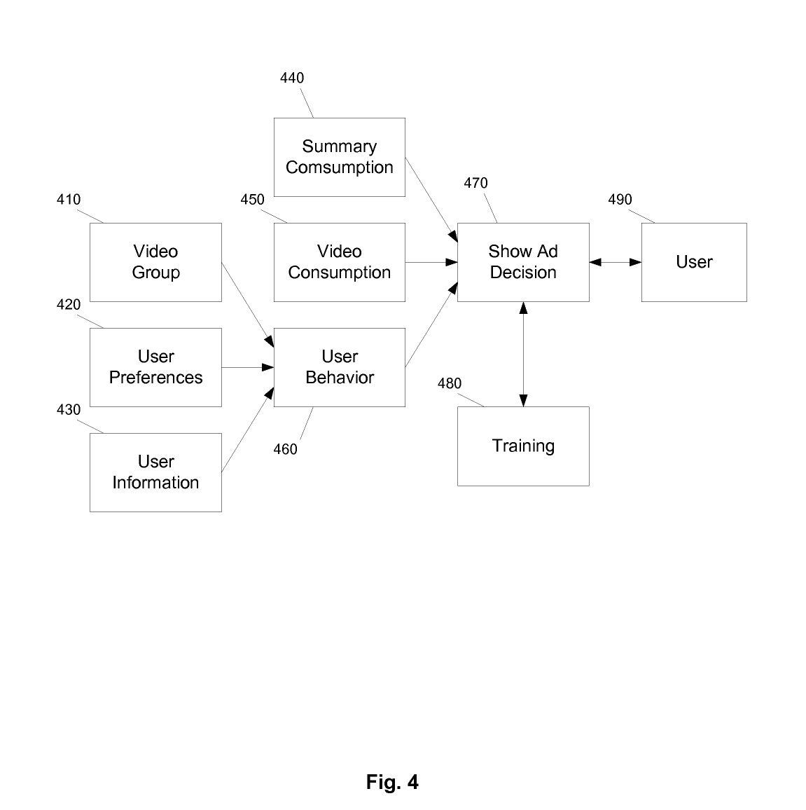

FIG. 4 illustrates an embodiment in which video summary usage information is used to decide when, where and how to display ads. Based on the audience engagement information from the embodiments discussed earlier, and information on which videos are becoming viral, a decision can be made on the display of advertisements.

In particular, the advertisement decision mechanism attempts to answer, among other things, questions such as: 1. when is a user willing to watch an ad to access content?; 2. which ads will get more viewers?; and 3. what is the behavior of a user in front of videos and ads. For example, it is possible to find the maximum non-intrusive ad insertion ratio for a type of user. In the advertisement industry today, a key parameter is the “visibility” of an advertisement by a user. Thus, knowing that a user will consume an advertisement because they have a strong interest in the content of the advertisement is very important. Working with short advertisements and having them inserted at the right moment in time and at the right location are also two important elements to increase the probability of visibility. Increasing the visibility of advertisements means that publishers can charge more for ads inserted in their pages. This is important and sought after for most brands and advertisement agencies. Also, the high levels of visibility of previews that are consumed in higher volume than long format videos produces an outstanding volume of video inventory that drives revenue too. In general, summaries or previews have higher volume than long format video that produces higher inventory for advertisements, which leads to more revenue for publishers. Embodiments of the invention utilize machine learning as described herein to help decide the right moment to insert an advertisement to maximize visibility which increases the price of those ads.

Video Group 410 represents the group to which the video has been assigned as discussed above in connection with FIG. 2 and FIG. 3. User Preferences 420 represents data obtained from previous interactions of a given user within that site or other sites. The user preferences may include one or more of the following:

1. type of contents that the user watches;

2. interaction with the summaries (data consumption of summaries, particular data consumption of summaries within different groups);

3. interaction with the videos (click-through rate, types of videos that the user consumes);

4. interaction with ads (time spent watching ads, video groups for which the ads are better tolerated); and

5. general behavior (time spent on site, general interactions with the site such as clicks, mouse gestures).

User Preferences 420 are obtained through observing the user behavior in one or more sites, through the interaction with summaries, videos, advertisements, and through monitoring the pages that the user visits. User Information 430 represents general information about the user to the extent that such information is available. Such information could include features such as gender, age, income level, marital status, political affiliation, etc. In some embodiments User Information 430 may be predicted based on a correlation with other information, such as postal code or IP address.

The data from 410, 420 and 430 is input to User Behavior 460, which defines, based on a computed figure of merit, whether the user is interested on a video pertaining to the Video Group 410. User Behavior 460 returns to the Show Ad Decision 470 a score that evaluates the user interest on the video content. The algorithm used in 460 can be updated based on the User 490 interaction with that content.

Summary Consumption 440 represents data about the interaction of the audience with the summary of that video such as described above in connection with FIG. 2 and FIG. 3. This can include number of summaries served, average time spent watching that summary, etc. Video Consumption 450 represents data about the interaction of the audience with the video (number of times a video has been watched, time spent watching the video, etc.)

Data from 440, 450 and 460 is used by Show Ad Decision 470, which decides whether an ad should be served to that user in that particular content. In general Show Ad Decision makes a determination on the anticipated level of interest of a particular advertisement to a particular user. Based on this analysis, a decision may be made to display an advertisement after a certain number of summary displays. User 490 interaction with the ad, the summary and the content is then used in Training 480 to update the Show Ad Decision 470 algorithm. Note that User Preferences represents historical information about the user, while Summary Consumption 440 and Video Consumption 450 represent data for the current situation of the user. Thus Show Ad Decision 470 is the result of the historical data with the current situation.

The machine learning mechanisms used in FIG. 4 decides whether an advertisement should be shown or not for a given summary and/or video. If an advertisement is shown, then the user interaction (e.g. if they watch it or not, if they click on it, etc.) are used for the next advertisement decision. The machine learning mechanism then updates the function score used by Show Ad Decision 470 which uses the input data (440, 450, 460) to decide whether the ad should be shown or not on a particular content and in which position.

Embodiments of the invention achieve better results in advertisement visibility by utilizing video summary usage information. Users have a stronger interest in watching a video after having watched a summary or preview. That is, users want to know something about a video before deciding whether or not to watch it. Once a user decides to watch a video because of something they saw in the preview, they will typically be more inclined to go through the advertisement and then the video to reach the point in the video where they can see the preview. In this way the preview acts as a hook to attract the user to the content and the use of summary usage information and user behavior allow the system to assess each user's tolerance for advertising. In this way advertisement visibility can be optimized.

The present invention has been described above in connection with several preferred embodiments. This has been done for purposes of illustration only, and variations of the inventions will be readily apparent to those skilled in the art and also fall within the scope of the invention.

In accordance with one aspect of the invention, there is provided a method of selecting advertisements comprising the steps of: analyzing a video comprising a plurality of frames to detect a plurality of parameters associated with said video; creating at least one summary of said video, wherein each said summary comprises a sequence of summary frames created based on video frames from said video; publishing said at least one summary making it available to be viewed by a user; collecting summary usage information from the consumption of said at least one summary by a user; and making a decision regarding an advertisement to present to said user based at least in part upon said summary usage information.

The step of making a decision may be further based on user behavior comprising user preferences and user information.

The user preferences may include information regarding a user's previous interaction with summaries, videos or advertisements.

The step of creating at least one summary may comprise the steps of: assigning said video to a group based on the values of said parameters; computing a score for a plurality of sequences of frames of said video using a score function and based on properties of said group; and selecting a summary of said video based on said score.

The step of selecting a summary may comprise ranking said plurality of sequences of frames based on a figure of merit and selecting one or more of highest ranking summaries.

The step of making a decision may be further based on properties of said group that said video is assigned to.

The method may further comprise the step of collecting video usage information from the consumption of said video, wherein the step of making a decision is further based on said video usage information.

A machine learning mechanism may be used by said step of making a decision.

The step of collecting summary usage information may comprise collecting data about the interaction of the user with the summary.

The step of creating at least one summary may comprise creating a plurality of summaries and wherein said step of publishing comprises making said plurality of summaries available to be viewed by a user.

What is claimed is:

1. A method of selecting advertisements comprising the steps of:
causing at least one processor to analyze a video comprising a plurality of frames to detect a plurality of parameters associated with said video;
creating at least one summary of said video, using the at least one processor, wherein each said summary comprises one or more sequences of frames created based on video frames from said video and is a short summary of key elements in said video;
publishing said at least one summary, using the at least one processor, making it available to be viewed by a user device, wherein said summary is viewed by a user in a display region of said user device and said video is accessed by a user through a user selection within said display region of said user device;
collecting summary usage information from the consumption of said at least one summary and video usage information associated with said video by a user, using the at least one processor, comprising collecting data related to the interaction of the user with the at least one summary and data related to the selection by the user of the video;
making a decision regarding an advertisement to present to said user, using the at least one processor, based at least in part upon said summary usage information and said video usage information.

2. The method of claim 1 wherein said step of making a decision is further based on user behavior comprising user preferences and user information.

3. The method of claim 2 wherein said user preferences includes information regarding a user's previous interaction with summaries, videos or advertisements.

4. The method of claim 1 wherein said step of creating at least one summary comprises the steps of:
assigning said video to a group based on said parameters;
computing a score for each of a plurality of sequences of frames of said video using a score function and based on properties of said group;
selecting one or more of said sequences of frames based on said score.

5. The method of claim 4 wherein said step of making a decision is further based on properties of said group that said video is assigned to.

6. The method of claim 1 further comprising the step of:
collecting video usage information from the consumption of said video; and
wherein said step of making a decision is further based on said video usage information.

7. The method of claim 1 wherein a machine learning mechanism is used by said step of making a decision.

8. The method of claim 1 wherein said step of creating at least one summary comprises creating a plurality of summaries and wherein said step of publishing comprises making said plurality of summaries available to be viewed by a user.

9. The method of claim 1 wherein said step of creating at least one summary comprises creating a plurality of summaries and wherein said step of publishing comprises publishing a different summary to each of a least two different users.

10. The method of claim 1 wherein said data related to the interaction of the user with the at least one summary comprises one or more items from the set consisting of: a number of seconds a user spends watching a summary, an area within a summary window that is clicked, an area within a summary in which the mouse has been placed, a number of times a user sees a summary, a time of a user mouse click relative to a playback of a summary, a time at which a user does a mouse-out event to stop watching a summary without a click, a number of click-throughs to view an original video, a number of total summary views, a number of clicks without watching a summary, a time spent by a user on a site, and a time spent by a user interacting with summaries.

11. A non-transitory computer readable medium encoded with codes for directing a processor to execute the method of claim 1.

12. The method of claim 1:
wherein said summary is viewed by a user through a mouse position over the display region of said user device and said video is accessed by a user through a mouse click within the display region of said user device; and
wherein said data related to the interaction of the user with the at least one summary comprises information relating to mouse position and mouse movement within the display region of said user device.
